(19) United States
(12) Patent Application Publication
(10) Pub. No.: US 2008/0247618 A1
(43) Pub. Date: Oct. 9, 2008

(54) INTERACTIVE DIAGNOSTIC DISPLAY SYSTEM

(76) Inventors: Andrew F. Laine, New York, NY (US); Yinpeng Jin, Baltimore, MD (US); Peter D. Esser, Smithtown, NY (US)

Correspondence Address: BAKER BOTTS L.L.P., 30 ROCKEFELLER PLAZA, 44TH FLOOR, NEW YORK, NY, 10112-4498, US

(21) Appl. No.: 11/941,468

(22) Filed: Nov. 16, 2007

Related U.S. Application Data
(63) Continuation of application No. PCT/US06/24488, filed on Jun. 20, 2006.
(60) Provisional application No. 60/692,678, filed on Jun. 20, 2005.

(51) Int. Cl. G06F 19/00

(52) U.S. Cl. 382/128

(57) ABSTRACT

In certain embodiments, an interactive diagnostic display system comprises a database, a digital data processing device, and a display. The database includes: (1) diagnostic data based on measurements of one or more characteristics of a patient's body; (2) denoising algorithms, each corresponding to a value of a denoising parameter; and (3) enhancement algorithms, each corresponding to a value of an enhancement parameter. The digital data processing device is operatively coupled to the database and configured to: (1) receive a denoising value and an enhancement value from a client input device; (2) based on the denoising value, apply the corresponding one of the denoising algorithms to the diagnostic data to generate denoised diagnostic data; (3) based on the enhancement value, apply the corresponding one of the enhancement algorithms to the denoised diagnostic data to generate enhanced denoised data; and (4) generate denoised and enhanced denoised images based on the respective denoised diagnostic data and the enhanced denoised diagnostic data. The display is operatively coupled to the digital data processing device and configured to simultaneously display the denoised diagnostic data and the enhanced denoised diagnostic data.

### CROSS REFERENCE TO RELATED APPLICATION

This application is based on Provisional Application Ser. No. 60/692,678, filed Jun. 20, 2005, which is incorporated herein by reference for all purposes and from which priority is claimed.

### TECHNICAL FIELD OF THE INVENTION

This invention relates generally to displaying diagnostic data and more particularly to an interactive diagnostic display system.

### BACKGROUND

Devices frequently collect or generate data that is used to generate images for display on a computer system. For medical applications, this data may be diagnostic data derived from measurement of one or more characteristics of a selected region of a patient's body, such as the patient's brain. Raw diagnostic data may be processed within a computer system for generation of images to be displayed. Images generated directly from raw diagnostic data may be unclear or otherwise inadequate. Thus, it is often desirable to apply one or more processing algorithms to the raw diagnostic data to produce images that are improved or otherwise more appropriate for diagnostic purposes. For example, it may be desirable to apply denoising and enhancement algorithms to the raw diagnostic data to generate an image for display. Some previous tools for displaying diagnostic data may display an image generated directly from the raw diagnostic data and an image generated after application of denoising and enhancement algorithms to the raw diagnostic data.

### SUMMARY OF THE INVENTION

According to the present invention, disadvantages and problems associated with previous diagnostic display techniques may be reduced or eliminated.

In certain embodiments, a computer-implemented interactive diagnostic display system includes a processing module and a display module. The processing module is operable to: (1) access diagnostic data derived from measurement of one or more characteristics of a selected region of a patient's body; (2) receive a user-selected value that specifies underlying values of one or more parameters of a processing algorithm to specify a particular processing algorithm that is to be applied to the diagnostic data to generate processed diagnostic data, the user-selected value abstracting the underlying values such that the user need not have knowledge of these underlying values to specify optimal processing for generating an image reflecting the user-selected value; (3) apply the particular processing algorithm to the diagnostic data according to the user-selected value to generate the processed diagnostic data; (4) generate the image reflecting the processed diagnostic data; and (5) communicate the image for display. The display module is operable to: (1) display the image; and (2) display a selection icon, in association with the displayed image, allowing a user to interactively adjust the user-selected value to adjust the underlying values for generation of a new image.

In certain embodiments, an interactive diagnostic display system comprises one or more memory modules, one or more digital processing modules, and a display. The one or more memory modules include diagnostic data derived from measurement of one or more characteristics of a patient's body. The one or more digital processing modules are operable to: (1) receive a denoising value that corresponds to values for one or more parameters of a denoising algorithm; (2) receive an enhancement value that corresponds to values for one or more parameters of an enhancement algorithm; (3) based on the values for the one or more parameters of the denoising algorithm that correspond to the denoising value, apply the denoising algorithm to the diagnostic data to generate denoised diagnostic data; (4) based on the values for the one or more parameters of the enhancement algorithm that correspond to the enhancement value, apply the enhancement algorithm to the denoised diagnostic data to generate the enhanced denoised diagnostic data; and (5) generate a denoised image from the denoised diagnostic data and an enhanced image from the enhanced denoised diagnostic data. The display is operable to display simultaneously the denoised image and the enhanced image.

In certain embodiments, an interactive diagnostic display system comprises a database, a digital data processing device, and a display. The database includes: (1) diagnostic data based on measurements of one or more characteristics of a patient's body; (2) denoising algorithms, each corresponding to a value of a denoising parameter; and (3) enhancement algorithms, each corresponding to a value of an enhancement parameter. The digital data processing device is operatively coupled to the database and configured to: (1) receive a denoising value and an enhancement value from a client input device; (2) based on the denoising value, apply the corresponding one of the denoising algorithms to the diagnostic data to generate denoised diagnostic data; (3) based on the enhancement value, apply the corresponding one of the enhancement algorithms to the denoised diagnostic data to generate enhanced denoised diagnostic data; and (4) generate denoised and enhanced denoised images based on the respective denoised diagnostic data and the enhanced denoised diagnostic data. The display is operatively coupled to the digital data processing device and configured to simultaneously display the denoised diagnostic data and the enhanced denoised diagnostic data.

Particular embodiments of the present invention may provide one or more technical advantages. Certain of these advantages may assist users such as medical doctors or other medical personnel in diagnosing and treating patients. Previous diagnostic display tools typically require the user to specify or adjust a number of parameters of one or more processing algorithms to display an image that is optimized for the user's particular diagnostic purposes relative to an image generated directly from raw diagnostic data. Often, the parameters that must be specified or adjusted are not intuitive or are otherwise difficult for the user to comprehend without specialized knowledge of the underlying processing algorithms.

In certain embodiments, the present invention abstracts underlying values of parameters of one or more processing algorithms into a single intuitive parameter that the user may specify or adjust, making it simpler for the user to interact with the display to generate an image considered optimal for the user's particular diagnostic purposes, especially where the user lacks specialized knowledge of the underlying processing algorithm. As an example, in certain embodiments, the present invention abstracts underlying values of parameters of a denoising algorithm into a single denoising value that the user may select to specify the underlying values of the parameters and thereby specify a particular denoising algorithm for use in processing diagnostic data to generate denoised diagnostic data and an associated denoised image. As a further example, in certain embodiments, the present invention abstracts underlying values of parameters of an enhancement algorithm into a single enhancement value that the user may select to specify the underlying values of the parameters and thereby specify a particular enhancement algorithm for use in processing denoised diagnostic data to generate enhanced denoised diagnostic data and an associated enhanced image. As a result of the abstraction of underlying parameter values, the user need not have knowledge of these underlying parameter values to specify particular processing for generating an image that is optimal for the user's particular diagnostic purposes.

Previous systems typically display only images reflecting raw diagnostic data and images reflecting the result of combined denoising and enhancement with respect to the raw diagnostic data. Previous systems typically do not display a denoised image from the result only of denoising with respect to the raw diagnostic data. In certain embodiments, in contrast to previous techniques, the present invention displays simultaneously: (1) a denoised image from the result only of denoising with respect to the raw diagnostic data; and (2) an enhanced image from the result of enhancement with respect to the denoised diagnostic data. Applying a denoising algorithm to the raw diagnostic data to generate denoised diagnostic data may yield a linear relationship between the raw diagnostic data and the denoised diagnostic data, and an accurate and smooth denoised image, to facilitate quantitative diagnostic analysis. In certain embodiments, the denoised diagnostic data may be preserved for such analysis. Applying an enhancement algorithm to the denoised diagnostic data to generate enhanced denoised diagnostic data may yield an enhanced image that provides improved visualization (e.g., improved contrast and spatial resolution) and facilitates quantitative diagnostic analysis. In certain embodiments, displaying simultaneously the denoised image with the corresponding enhanced images provides valuable diagnostic benefits.

In certain embodiments, the present invention provides graphical tools to allow the user to adjust, interactively and intuitively, the denoising value to adjust the underlying parameter values of the denoising algorithm, the enhancement value to adjust the underlying parameter values of the enhancement algorithm, or both. In certain embodiments, the present invention provides graphical tools to allow the user to adjust simultaneously the denoising value and the enhancement value. In certain embodiments, in response to the user adjusting such a user-selected value, the present invention generates and displays in substantially real time a modified image reflecting the adjustment to the associated underlying parameter values. For example, in response to the user adjusting the denoising value, the present invention may generate and display in substantially real time both a new denoising image from the new denoised diagnostic data and a new enhancement image from the corresponding new enhanced denoised diagnostic data. In certain embodiments, the ability for the user to intuitively and interactively adjust such values to control the underlying denoising and enhancement algorithms and associated parameters, and view in substantially real time the results of such adjustments on the denoised and enhanced images, provides valuable diagnostic benefits, especially where the user lacks specialized knowledge of the underlying algorithms and associated parameters.

In certain embodiments, the one or more processing algorithms of the present invention comprise a three-dimensional wavelet-based image processing tool (e.g., a wavelet filter), comprising both the denoising and enhancement functionality. The wavelet filter may be based on multi-scale thresholding and cross-scale regularization. In certain embodiments, the user may be able to adjust one or more denoising parameters and/or one or more enhancement parameters of the wavelet filter using the graphical tools of the present invention.

Certain embodiments of the present invention may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates an example system for interactive diagnostic display;

FIGS. 2A-2D illustrate example interactive diagnostic displays; and

FIG. 3 illustrates an example method for interactive diagnostic display.

### DESCRIPTION OF EXAMPLE EMBODIMENTS

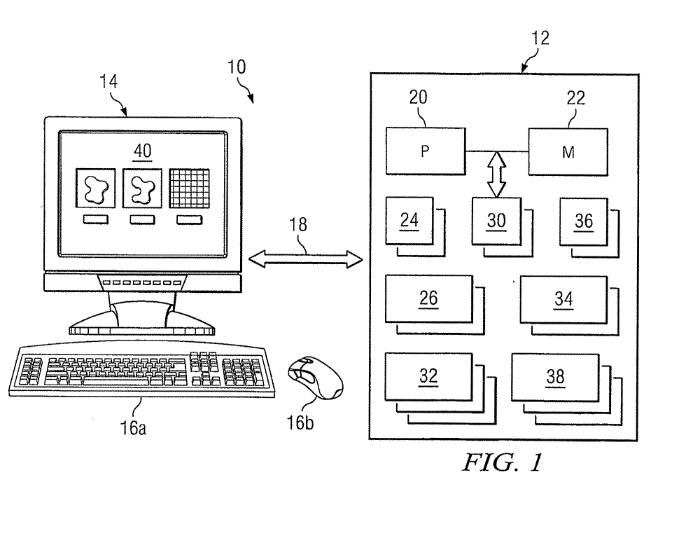

FIG. 1 illustrates an example system 10 for interactive diagnostic display. System 10 includes a processing module 12, a display module 14, and one or more input devices 16. Although this particular implementation of system 10 is illustrated and primarily described, the present invention contemplates system 10 including any suitable components and having any suitable configuration, according to particular needs. In general, system 10 provides certain processing and display functionality that, in certain embodiments, facilitates the optimization and evaluation of diagnostic data.

Throughout this description, a “user” may refer to a human user or a software application operable to perform certain functions, either automatically or in response to interaction with a human user. Human users of system 10 may include any suitable individuals. In certain embodiments, users of system 10 include individuals in the medical profession (e.g., medical doctors, lab technicians, physician's assistants, nurses, or any other suitable individuals), who may use system 10 to assist in diagnosing a patient. For example, a medical doctor may use system 10 to view images generated from diagnostic data captured by one or more modalities. As a particular example, the present invention may provide an interactive diagnostic display for diagnosis of cancer, heart disease, or any other suitable aspect of health according to particular needs.

In certain embodiments, system 10 is a computer system, such as a personal computer (PC), which in certain embodiments might include a desktop or laptop PC. Although system 10 is described primarily as a PC, the present invention contemplates system 10 being any suitable type of computer system, according to particular needs. For example, system 10 could include a client-server system. In any event, system 10 is should be sufficiently powerful in terms of its processing and memory capabilities to process diagnostic data, and generate and display corresponding images, as described herein. System 10 may include any suitable input devices, output devices, mass storage media, processors, memory, or other suitable components for receiving, processing, storing, and communicating information. Furthermore, system 10 may operate using any suitable platform, according to particular needs. The operations of system 10 may be implemented in software, firmware, hardware, or any suitable combination of these.

System 10 includes one or more display modules 14, each of which may include a computer monitor, television, projector, or any other suitable type of display device. In certain embodiments, display module 14 is appropriately calibrated for linearity and contrast resolution. A monitor calibration tool may be attached to display module 14, which may feed back through a serial port, USB port, or other suitable input/output connection of display module 14. This tool may help ensure that the intensity and brightness are linear with the data output, if appropriate.

System 10 includes one or more input devices 16, which may be used by a user of system 10 to interact with processing module 12 and display module 14. Input devices 16 may include a keyboard 16a, a mouse 16b, or any other suitable input devices. Although particular input devices 16 are illustrated and described, the present invention contemplates system 10 receiving input from a user in any suitable manner. For example, display device 14 may include touch-screen capabilities. As another example, one or more applications running on processing module 12 may interact with system 10 to interactively select certain inputs. As yet another example, system 10 may include voice recognition capabilities such that a user of system 10 may speak into an input device 16 (e.g., a microphone) to input commands or data.

The components of system 10, such as processing module 12, display module 14, and input devices 16, may be local to or geographically remote from one another, according to particular needs. For example, processing module 12 may be geographically remote from display module 14 and/or input devices 16. The components of system 10 may communicate with one another, either directly or indirectly, using a communication link 18. In certain embodiments, communication link 18 may include one or more computer buses, local area networks (LANs), metropolitan area networks (MANs), wide area networks (WANs), a global computer network such as the Internet, or any other wireline, optical, wireless, or other links.

Processing module 12 may include one or more processing units 20 and one or more memory modules 22 (which will be referred to as “processing unit 20” and “memory module 22” throughout the remainder of this description). In certain embodiments, operations performed by processing module 12 are collectively performed by processing unit 20 and memory module 22. Processing unit 20 may include any suitable type of processor, according to particular needs. In certain embodiments, processing unit 20 includes dual-processing capabilities. Memory module 22 may take the form of volatile or non-volatile memory including, without limitation, magnetic media, optical media, random access memory (RAM), read-only memory (ROM), removable media, or any other suitable memory component. In certain embodiments, memory module 22 comprises one or more databases, such as one or more Structured Query Language databases or any other suitable types of databases. In certain embodiments, processing module 12 includes sufficient memory to perform image processing. For example, in certain embodiments memory unit 12 includes at least four gigabytes of memory.

Processing module 12 may include or otherwise be associated with diagnostic data 24. Diagnostic data 24 may include data derived from the measurement of one or more characteristics of a selected region of a patient's body. The selected region of the patient's body may include the entire body, an organ of the body (e.g., the brain or heart), or any other suitable region. As particular examples, diagnostic data 24 may include positron emission tomography (PET) data, single photon emission computed tomography (SPECT) data, computerized tomography (CT) scan data, computed axial tomgraphy (CAT) scan data, magnetic resonance imaging (MRI) data, electro-encephalogram (EEG) data, ultrasound data, single photon planar data, or any other suitable type of data derived from measurement of one or more characteristics of a selected region of a patient's body. Although diagnostic data 24 is described primarily as being derived from the measurement of one or more characteristics of a selected region of a patient's body, the present invention contemplates diagnostic data 24 being derived from the measurement of one or more characteristics of any suitable object. Moreover, although diagnostic data 24 that is derived using particular types of modalities is described, the present invention contemplates diagnostic data 24 being derived using any suitable modality or other device, according to particular needs.

Processing module 12 is operable to access diagnostic data 24. Diagnostic data 24 may be provided to processing module 12 in any suitable manner, according to particular needs. For example, diagnostic data may be previously generated, and a user of system 10 may load diagnostic data 24 onto processing module 12 (e.g., using a CD-ROM or USB flash drive), diagnostic data 24 may be accessed and/or uploaded via a network connection to another computer such as a server or database, or diagnostic data 24 may be accessed in any other suitable manner according to particular needs. As another example, a medical device may be coupled to processing module 12 and may communicate diagnostic data 24 to processing module 12 in substantially real time.

In certain embodiments, diagnostic data 24 includes sufficient data for system 10 to render one or more images of the selected region of the patient's body. For example, diagnostic data 24 for a patient's brain (or other selected region of the patient's body) may include sufficient data to render one or more transaxial images of the selected region, one or more coronal images of the selected region, and/or one or more sagittal images of the selected region. In general, images generated directly from diagnostic data 24 may lack clarity or may be otherwise unsuitable for use in diagnosis. For example, diagnostic data 24 may include undesirable quantities of noise. Thus, it may be desirable to apply one or more processing algorithms to diagnostic data 24 to modify or improve images generated using diagnostic data 24. The present invention contemplates applying any suitable processing algorithm to diagnostic data 24, according to particular needs.

Each processing algorithm may be associated with one or more parameters. Previous diagnostic display tools typically require the user to specify or adjust a number of parameters of one or more processing algorithms to display an image that is optimized for the user's particular diagnostic purposes relative to an image generated directly from raw diagnostic data 24. Often, the parameters that must be specified or adjusted are not intuitive or are otherwise difficult for the user to comprehend without specialized knowledge of the underlying processing algorithms.

In certain embodiments, processing module 12 is operable to receive a user-selected value that specifies underlying values of one or more parameters of a processing algorithm to specify a particular processing algorithm that is to be applied to the diagnostic data to generate processed diagnostic data. The particular processing algorithm refers to the processing algorithm having the appropriate values for the underlying parameters according to the user-specified value and the mappings between the values that the user can select and the underlying values of the one or more parameters of the processing algorithm. The user-selected value may abstract the underlying values of the one or more parameters of the processing algorithm such that the user need not have knowledge of these underlying values to specify optimal processing for generating an image reflecting the user-selected value. Examples of this concept are described more fully below.

In certain embodiments, the one or more processing algorithms include one or more denoising algorithms 26, which may be included on or otherwise associated with processing module 12. In general, denoising refers to the removal of noise from noisy data to obtain the “true” data. Noisy data may include, for example, data that is infected with errors due to the nature of the collection, measuring, or sensoring procedures used to capture or generate the data. Thus, it is often the goal of denoising to apply a sufficiently aggressive algorithm to remove as much noise as possible without removing an excessive amount, if any, of the “true” data. Diagnostic data 24 may include noise. Moreover, the one or more processing algorithms of previous diagnostic display tools are generally too aggressive in attempting to eliminate noise from an image generated from raw diagnostic data, often sacrificing much of the “true” data. According to certain embodiments of the present invention, however, the one or more processing algorithms applied to diagnostic data 24 may preserve more of the “true” data, while still eliminating a sufficient amount of noise, than previous techniques. A denoising algorithm 26 may be used to remove at least a portion of the noise from diagnostic data 24, resulting in denoised diagnostic data 30. In certain embodiments, processing module 12 may apply denoising algorithm 26 to diagnostic data 24 to generate denoised diagnostic data 30, which may be used to generate a denoised image 32 from denoised diagnostic data 30.

Denoising algorithm 26 may include any suitable denoising algorithm. As an example, denoising algorithm 26 may include a cross-scale regularization algorithm. Additionally or alternatively, denoising algorithm 26 may include one or more discrete dyadic wavelet transforms and the one or more parameters of the denoising algorithm may include one or more wavelet coefficient thresholds for use in the one or more discrete dyadic wavelet transforms. Although these particular examples of denoising algorithms 26 are described, the present invention contemplates using any suitable denoising algorithms 26, according to particular needs.

Denoising algorithm 26 may include one or more parameters, which may be used to specify the level of denoising that is applied to diagnostic data 32. For example, a higher denoising level may reflect more aggressive noise removal, which may or may not be accompanied by stronger smoothing of the resulting denoised image 32. In certain embodiments, processing module 12 receives a user-selected denoising value that specifies underlying values of one or more parameters of a denoising algorithm 26 to specify a particular denoising algorithm 26 that is to be applied to diagnostic data 24 to generate denoised diagnostic data 30. The user-selected denoising value may abstract the underlying values of the one or more parameters of denoising algorithm 26 such that the user need not have knowledge of these underlying values to specify an optimal denoising level for the denoised image 32. Thus, in certain embodiments, the present invention may reduce a plurality of parameters of denoising algorithm 26 to a single intuitive parameter that may be specified by a user from a range of values. For example, the user-selected denoising value may include a number between zero and ten inclusive, zero specifying the lowest level of denoising and ten specifying the highest level of denoising.

The mappings between the denoising values that the user can select and the underlying values of the one or more parameters of denoising algorithm 26 may be configured and maintained in any suitable manner, according to particular needs. As described above, in one example the one or more parameters of denoising algorithm 26 include one or more wavelet coefficient thresholds for use in one or more discrete dyadic wavelet transforms that make up denoising algorithm 26. In these embodiments, the denoising values the user can specify may abstract these one or more wavelet coefficient thresholds.

Suppose, for example, that a multi-scale denoising implementation involves three-level decomposition, each associated with one or more wavelet coefficients. In certain embodiments, the mapping between the denoising values that the user can select (e.g., zero through ten) and the underlying values of the wavelet coefficient thresholds for each level may be computed according to the following formulas:

Second Level: real threshold value=noise level*a/4*4.50

Third Level: real threshold value=noise level*a/4*9

In this example, a represents the user-selected denoising value (e.g., zero through ten), and noise level may be estimated from the diagnostic data 24 in any suitable manner. Moreover, in this example, the wavelet coefficients for the first level may not be affected by the user-selected value (i.e., a). Instead, the first level wavelet coefficients may be processed using cross-scale regularization. This may be appropriate in certain embodiments because the first level may be sufficiently noisy that it is useful to process that level using a particular algorithm that the user cannot configure by selectively modifying parameters.

In certain embodiments, if the user-selected denoising value is relatively low (e.g., one), then the mapping between the user-selected denoising value and the one or more underlying values of the one or more parameters (e.g., the wavelet coefficient thresholds) of denoising algorithm 26 would specify a value for each of the coefficients such that less noise is removed from diagnostic data 24 to generate denoised diagnostic data 30. In certain embodiments, if the user-selected denoising value is relatively higher than in the previous example (e.g., five), then the mapping between the user-selected denoising value and the one or more underlying values of the one or more parameters (e.g., the wavelet coefficient thresholds) of denoising algorithm 26 would specify a value for each of the coefficients such that an intermediate amount of noise is removed from diagnostic data 24 to generate denoised diagnostic data 30. In certain embodiments, if the user-selected denoising value is relatively high (e.g., nine), then the mapping between the user-selected denoising value and the one or more underlying values of the one or more parameters (e.g., the wavelet coefficient thresholds) of denoising algorithm 26 would specify a value for each of the coefficients such that a large quantity of noise is removed from diagnostic data 24 to generate denoised diagnostic data 30.

Processing module 12 is operable to apply the particular denoising algorithm 26 to diagnostic data 24 to generate denoised diagnostic data 30. The particular denoising algorithm 26 refers to algorithm 26 having the appropriate values for the underlying parameters according to the user-specified denoising value and the mappings between the denoising values that the user can select and the underlying values of the one or more parameters of denoising algorithm 26. In certain embodiments, application of the particular denoising algorithm 26 to diagnostic data 24 to generate denoised diagnostic data 30 yields a linear relationship between diagnostic data 24 and denoised diagnostic data 30. This linear relationship may facilitate quantitative analysis with respect to denoised diagnostic data 30.

In certain embodiments, the one or more processing algorithms include one or more enhancement algorithms 34, which may be included on or otherwise associated with processing module 12. In general, enhancement refers to emphasizing boundaries in an image. Processing module 12 may apply an enhancement algorithm 34 to denoised diagnostic data 30 to generate enhanced denoised diagnostic data 36, which may be used to generate an enhanced image 38 from enhanced denoised diagnostic data 36. While denoising algorithm 26 may remove a portion of diagnostic data 24 to reduce or eliminate noise, enhancement algorithm 34 may amplify portions of the data to which it is applied. Thus, in certain embodiments, it may be desirable to amplify the data after reduction or elimination of noise because, depending on the level of denoising selected by the user, the user can be more sure that the denoised data is closer to the “true” data than the raw diagnostic data 24. Although enhancement algorithm 34 is described primarily as being applied to denoised diagnostic data 30 to generate enhanced denoised data 36, the present invention contemplates applying enhancement algorithm 34 to diagnostic data 24, if appropriate. Although particular example enhancement algorithms 34 are described, the present invention contemplates using any suitable enhancement algorithms 34, according to particular needs.

Each enhancement algorithm 34 may include one or more parameters, which may be used to specify the level of enhancement that is to be applied to denoised diagnostic data 30. For example, the one or more parameters of enhancement algorithm 34 may include an edge confidence level. In certain embodiments, a higher enhancement level may provide stronger enhancement to image features. In certain embodiments, processing module 12 receives a user-selected enhancement value that specifies underlying values of one or more parameters of an enhancement algorithm 34 to specify a particular enhancement algorithm 34 that is to be applied to denoised diagnostic data 30 to generate enhanced denoised diagnostic data 36. The user-selected enhancement value may abstract the underlying values of the one or more parameters of enhancement algorithm 34 such that the user need not have knowledge of these underlying values to specify an optimal enhancement level for enhanced image 38. Thus, in certain embodiments, the present invention may reduce a plurality of parameters of enhancement algorithm 34 to a single intuitive parameter that may be specified by a user from a range of values. For example, the user-selected enhancement value may include a number between zero and ten inclusive, zero specifying the lowest level of enhancement and ten specifying the highest level of enhancement.

The mappings between the enhancement values that the user can select and the underlying values of the one or more parameters of enhancement algorithm 34 may be configured and maintained in any suitable manner, according to particular needs. In certain embodiments, the one or more parameters of enhancement algorithm 34 may include the same or other wavelet coefficient thresholds as those described above with reference to denoising algorithm 26. In these embodiments, the enhancement values that the user can select may abstract these one or more wavelet coefficient thresholds.

Suppose, as described in the above denoising example, that a multi-scale denoising implementation involves three-level decomposition, each associated with one or more wavelet coefficients. In certain embodiments, the mapping between the enhancement values that the user can select (e.g., zero through ten) and the underlying values of the wavelet coefficient thresholds for each level may be computed according to the following formula:

real gain=1+a/3

In this example, a represents the user-selected enhancement value (e.g., zero through ten), and real gain represents the amplification factor for the wavelet coefficients. Thus, if the user-selected enhancement value is five (i.e., a=5), then the real gain (i.e., the amplification factor for the wavelet coefficients) is 2.67.

In certain embodiments, if the user-selected enhancement value is relatively low (e.g., one), then the mapping between the user-selected enhancement value and the one or more underlying values of the one or more parameters (e.g., the wavelet coefficient thresholds) of enhancement algorithm 34 would specify a value for each of the coefficients such that lower enhancement is performed on denoised diagnostic data 30 to generate enhanced denoised diagnostic data 36. In certain embodiments, if the user-selected enhancement value is relatively higher than in the previous example (e.g., five), then the mapping between the user-selected enhancement value and the one or more underlying values of the one or more parameters (e.g., the wavelet coefficient thresholds) of enhancement algorithm 34 would specify a value for each of the coefficients such that an intermediate amount of enhancement is performed on denoised diagnostic data 30 to generate enhanced denoised diagnostic data 36. In certain embodiments, if the user-selected enhancement value is relatively high (e.g., nine), then the mapping between the user-selected enhancement value and the one or more underlying values of the one or more parameters (e.g., the wavelet coefficient thresholds) of enhancement algorithm 34 would specify a value for each of the coefficients such that a large amount of enhancement is performed on denoised diagnostic data 30 to generate enhanced denoised diagnostic data 36.

In certain embodiments, processing module 12 is operable to apply the particular enhancement algorithm 34 to denoised diagnostic data 30 to generate enhanced denoised diagnostic data 36. The particular enhancement algorithm 34 refers to algorithm 34 having the appropriate values for the underlying parameters according to the user-specified enhancement value and the mappings between the enhancement values that the user can select and the underlying values of the one or more parameters of enhancement algorithm 34.

In certain embodiments, the one or more processing algorithms of the present invention (e.g., the one or more denoising algorithms and/or the one or more enhancement algorithms) are provided using a three-dimensional wavelet-based image processing tool (e.g., a wavelet filter) that comprises both the denoising and enhancement functionality. The wavelet filter may be based on multi-scale thresholding and cross-scale regularization. In certain embodiments, the user may be able to adjust one or more denoising parameters and/or one or more enhancement parameters of the wavelet filter using the graphical tools of the present invention.

In certain embodiments, the particular processing algorithm provided by this wavelet filter may be based on a dyadic wavelet transform, using the first derivative of a cubic spline function as the wavelet basis. In certain embodiments, conventional multi-scale thresholding is generalized so that each sub-band is processed with a distinct thresholding operator. Using such techniques, effective denoising and signal recovering may be achieved using a cross-scale regularization process in which detailed signal features within multi-scale sub-bands are recovered by estimating edge locations from coarser levels within the wavelet expansion. In certain embodiments, the thresholding operator may be applied to the modulus of wavelet coefficients, rather than to individual components, which may provide more accurate orientation selectivity. The one or more user-selected parameters may specify one or more underlying parameters provided to the wavelet filter. Additional details regarding the one or more processing algorithms (e.g., the one or more denoising algorithms and/or the one or more enhancement algorithms) are described below under the heading “Example Processing Algorithm.”

Processing module 12 is operable to generate denoised image 32 from denoised diagnostic data 30 and communicate denoised image 32 for display. For example, processing module 12 may communicate denoised image 32 to display module 14 for display. Additionally, processing module 12 is operable to generate enhanced image 38 from enhanced denoised diagnostic data 36 and communicate enhanced image 38 for display. For example, processing module 12 may communicate enhanced image 38 to display module 14 for display.

Display module 14 is operable to receive the one or more images (e.g., denoised image 32 and enhanced image 38) generated and communicated by processing module 12 for display. For example, display module 14 may receive an image reflecting the diagnostic data processed using the processing algorithm according to the user-selected value. Display module 14 may display the received image reflecting the user-selected value. As a particular example, display module may receive denoised image 32 and enhanced image 38. Display module 14 may display simultaneously denoised image 32 and enhanced image 38. In certain embodiments, the ability to view both denoised image 32 and enhanced image 38 simultaneously according to the user-specified values of the one or more parameters of the processing algorithm, as specified by the user-selected values, may improve a user's ability to optimize the images for diagnostic purposes.

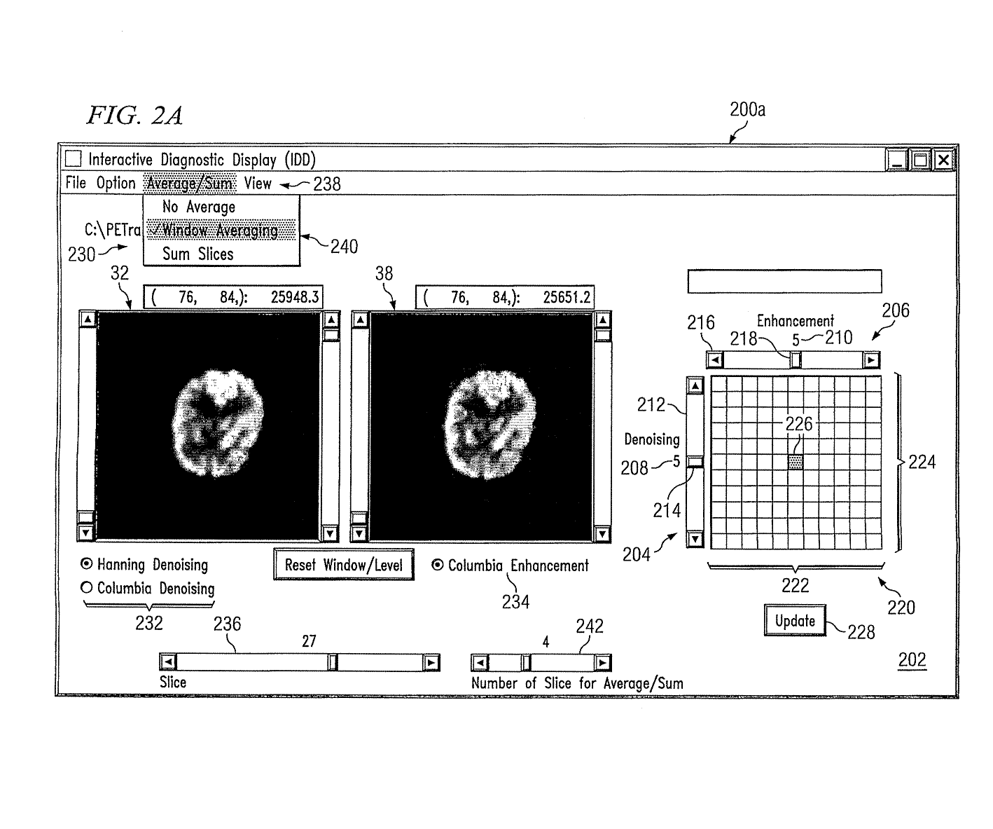

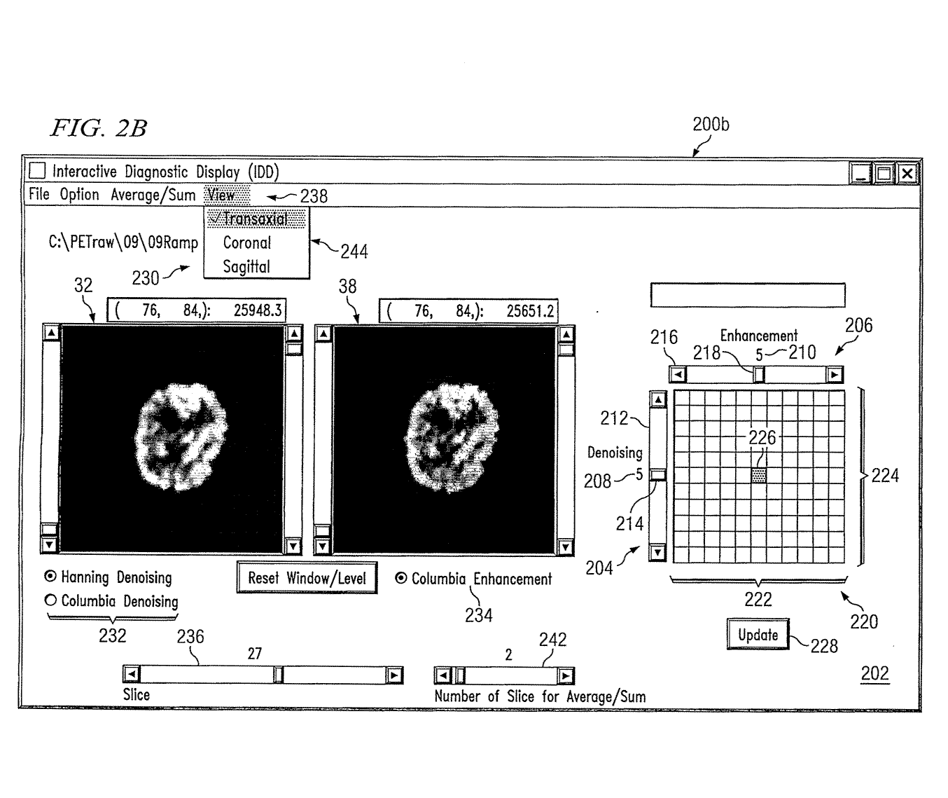

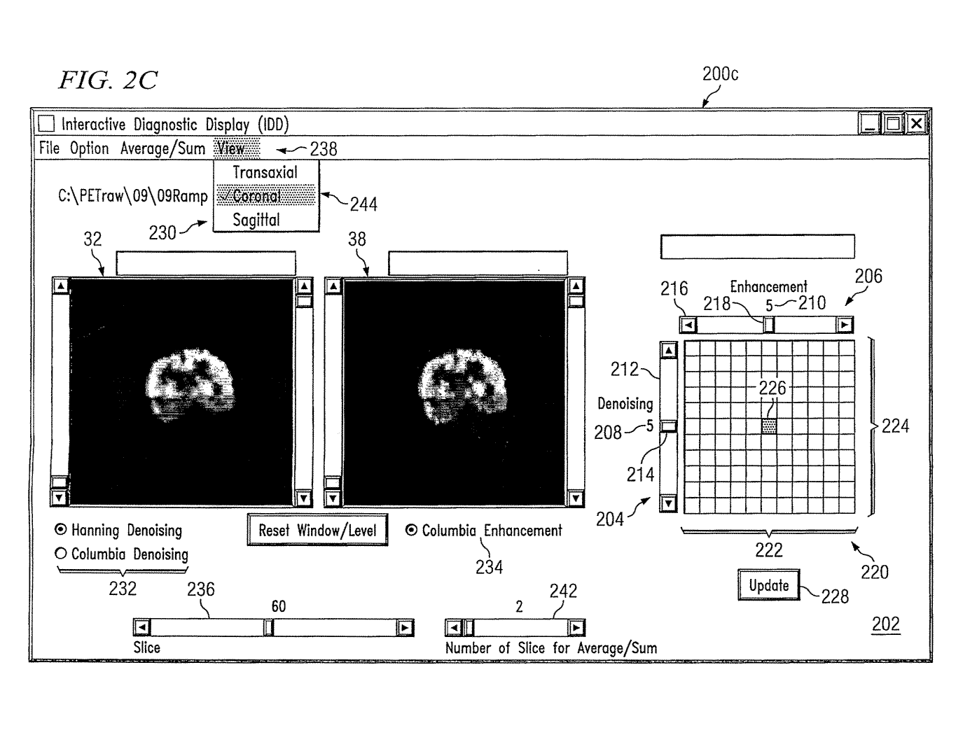

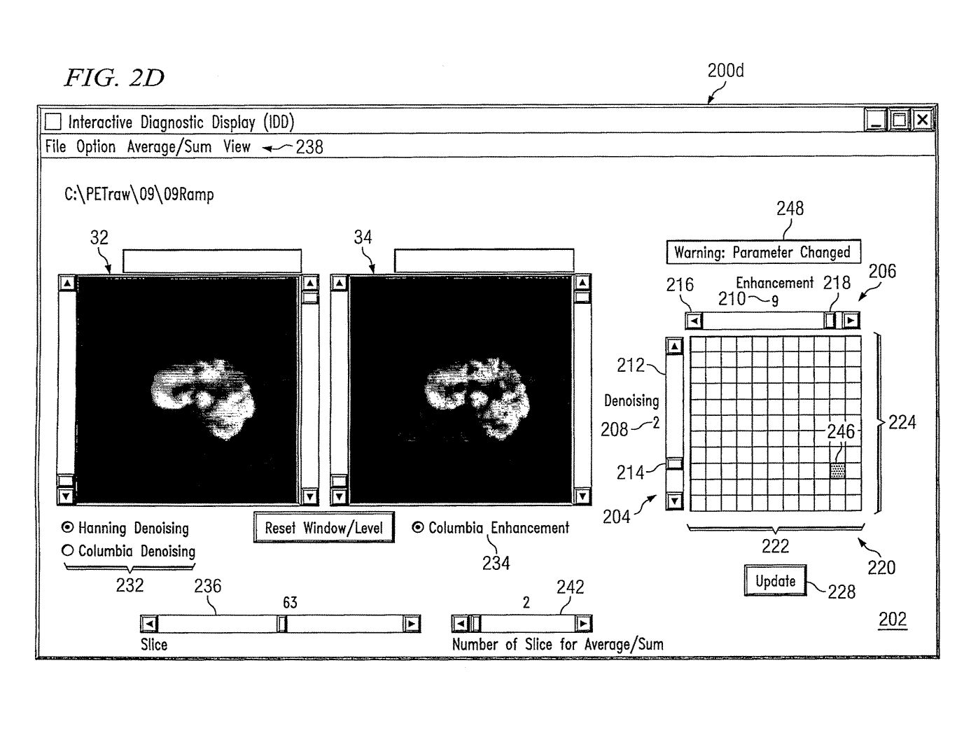

In certain embodiments, the present invention provides a graphical user interface (GUI) 40 for display using display module 14 that may be used by a user of system 10 to interact with various components of system 10. Particular example GUIs are described more fully below with reference to FIGS. 2A-2D. Display module 14 may be operable to display one or more selection icons, in association with a displayed image (e.g., denoised image 32 or enhanced image 38), which may allow the user to interactively adjust the user-selected value to adjust the underlying values of the one or more parameters of the processing algorithm for generation of a new image. For example, display module 14 may be operable to display a denoising selection icon, in association with the displayed denoised image 32, allowing a user to interactively adjust the user-selected denoising value to adjust the underlying values of the one or more parameters of denoising algorithm 26 for generation of a new denoised image 32. Additionally or alternatively, display module 14 may be operable to display an enhancement selection icon, in association with the displayed enhanced image 38, allowing a user to interactively adjust the user-selected enhancement value to adjust the underlying values of the one or more parameters of enhancement algorithm 34 for generation of a new enhanced image 38.

The one or more selection icons may have any suitable format, according to particular needs. For example, the denoising selection icon may be a first slider allowing the user to slide a first marker along the first slider to interactively adjust the user-selected denoising value. Additionally or alternatively, the enhancement selection icon may be a second slider allowing the user to slide a second marker along the second slider to interactively adjust the user-selected enhancement value. In certain embodiments, display module 14 is operable to display a grid that includes a plurality of columns each corresponding to a particular denoising value and a plurality of rows each corresponding to a particular enhancement value such that each intersection of the grid corresponds to a particular combination of denoising and enhancement values. In such embodiments, user selection of a particular intersection of the grid may specify simultaneously the user-selected denoising value and the user-selected enhancement value. In certain embodiments, each of the user-selected denoising value and the user-selected enhancement value is a number between zero and ten inclusive. Although particular techniques are described for selection of values of the one or more parameters of the processing algorithms (e.g., denoising algorithm 26 and enhancement algorithm 34), the present invention contemplates any suitable technique according to particular needs.

In certain embodiments, in response to user selection of a portion of denoised image 32 for display, display module 14 is operable to display simultaneously the selected portion of denoised image 32 and a corresponding portion of enhanced image 38. Similarly, in certain embodiments, in response to user selection of a portion of enhanced image 38 for display, display module 14 is operable to display simultaneously the selected portion of enhanced image 38 and a corresponding portion of denoised image 32.

In operation of an example embodiment of system 10, processing module 12 may access diagnostic data 24. In certain embodiments, diagnostic data 24 is derived from measurement of one or more characteristics of a selected region of a patient's body. Processing module 12 may receive a user-selected value that specifies underlying values of one or more parameters of a processing algorithm to specify a particular processing algorithm that is to be applied to diagnostic data 24 to generate processed diagnostic data. In certain embodiments, the user-selected value abstracts the underlying values of the one or more parameters of the processing algorithm such that the user need not have knowledge of these underlying values to specify optimal processing for generating an image.

Processing module 12 may apply the particular processing algorithm to diagnostic data 24 according to the user-selected value to generate the processed diagnostic data. Processing module 12 may generate an image from the processed diagnostic data communicate the image for display. For example, processing module 12 may communicate the generated image to display module 14 for display. Display module 14 may display the image reflecting the user-selected value. In certain embodiments, display module 14 displays a selection icon, in association with the displayed image, allowing a user to interactively adjust the user-selected value to adjust the underlying values of the one or more parameters of the processing algorithm for generation of a new image.

In operation of an example embodiment of system 10 in which the processing algorithms include a denoising algorithm 26 and an enhancement algorithm 34, processing module 12, at the request of a user of system 10 for example, accesses diagnostic data 24 derived from measurement of one or more characteristics of a selected region of a patient's body. Processing module 12 receives a user-selected denoising value that specifies underlying values of one or more parameters of a denoising algorithm 26 to specify a particular denoising algorithm 26 that is to be applied to diagnostic data 24 to generate denoised diagnostic data 30. Processing module 12 receives a user-selected enhancement value that specifies underlying values of one or more parameters of an enhancement algorithm 34 to specify a particular enhancement algorithm 34 that is to be applied to denoised diagnostic data 30 to generate enhanced denoised diagnostic data 36. The user-selected denoising and enhancement values may be received in any suitable manner and in any suitable order, according to particular needs.

Processing module 12 may apply the particular denoising algorithm 26 to diagnostic data 24 to generate denoised diagnostic data 30, and processing module 12 may apply the particular enhancement algorithm 34 to denoised diagnostic data 30 to generate enhanced denoised diagnostic data 36. Processing module 12 may generate for simultaneous display: (a) denoised image 32 reflecting denoised diagnostic data 30 according to the user-selected denoising value; and (b) enhanced image 38 reflecting enhanced denoised diagnostic data 36 according to the user-selected enhancement value. Processing module 12 may communicate denoised image 32 and enhanced image 38 for display. For example, processing module 12 may communicate denoised image 32 and enhanced image 38 to display module 14 for display. Display module may display simultaneously denoised image 32 reflecting the user-selected denoising value and enhanced image 38 reflecting the user-selected enhancement value.

Processing module 12 may determine whether it has received an indication from a user to interactively adjust: (a) the user-selected denoising value to adjust the underlying values of the one or more parameters of denoising algorithm 26 for generation of a new denoised image 32; (b) the user-selected enhancement value to adjust the underlying values of the one or more parameters of enhancement algorithm 34 for generation of a new enhanced image 38; or (c) both. If processing module 12 determines that it has not received one of these types of indications from the user, then, in certain embodiments, processing module may wait for such an indication from the user until the software application supporting the interactive diagnostic display system 10 is terminated. If processing module 12 determines that it has received such an update, then processing module 12 may determine the type of indication it received from the user.

For example, processing module 12 may determine whether the user is requesting to interactively adjust both the user-selected denoising value and the user-selected enhancement value. If processing module 12 determines that the user is requesting to interactively adjust both the user-selected denoising value and the user-selected enhancement value, then processing module 12 may, in the manner described above, generate: (1) a new denoised image 32 from new denoised diagnostic data 30 generated according to the adjusted the user-selected denoising value; and (2) a new enhanced image 38 from new enhanced denoised diagnostic data 36 generated according to the adjusted the user-selected enhancement value.

As another example, processing module 12 may determine whether the user is requesting to interactively adjust only the user-selected denoising value. If processing module 12 determines that the user is requesting to interactively adjust only the user-selected denoising value, then processing module 12 may, in the manner described above, generate: (1) a new denoised image 32 from new denoised diagnostic data 30 generated according to the adjusted the user-selected denoising value; and (2) a new enhanced image 38 from new enhanced denoised diagnostic data 36 generated according to the adjusted the user-selected enhancement value. In certain embodiments, a new enhanced image 38 may be generated because enhanced denoised diagnostic data 36 (from which enhanced image 38 is generated) is generated by applying the particular enhancement algorithm 34 to denoised diagnostic data 30, which may have changed due to the user's request.

As another example, processing module 12 may determine whether the user is requesting to interactively adjust only the user-selected enhancement value. If processing module 12 determines that the user is requesting to interactively adjust only the user-selected enhancement value, then the processing module may, in the manner described above, generate a new enhanced image 38 from new enhanced denoised diagnostic data 36 generated according to the adjusted user-selected enhancement value.

Particular embodiments of the present invention may provide one or more technical advantages. Certain of these advantages may assist users such as medical doctors or other medical personnel in diagnosing and treating patients. Previous diagnostic display tools typically require the user to specify or adjust a number of parameters of one or more processing algorithms to display an image that is optimized for the user's particular diagnostic purposes relative to an image generated directly from raw diagnostic data 24. Often, the parameters that must be specified or adjusted are not intuitive or are otherwise difficult for the user to comprehend without specialized knowledge of the underlying processing algorithms.

In certain embodiments, the present invention abstracts underlying values of parameters of one or more processing algorithms into a single intuitive parameter that the user may specify or adjust, making it simpler for the user to interact with the display to generate an image considered optimal for the user's particular diagnostic purposes, especially where the user lacks specialized knowledge of the underlying processing algorithm. As an example, in certain embodiments, the present invention abstracts underlying values of parameters of a denoising algorithm 26 into a single denoising value that the user may select to specify the underlying values of the parameters and thereby specify a particular denoising algorithm 26 for use in processing diagnostic data 24 to generate denoised diagnostic data 30 and an associated denoised image 32. As a further example, in certain embodiments, the present invention abstracts underlying values of parameters of an enhancement algorithm 34 into a single enhancement value that the user may select to specify the underlying values of the parameters and thereby specify a particular enhancement algorithm 34 for use in processing denoised diagnostic data 30 to generate enhanced denoised diagnostic data 36 and an associated enhanced image 38. As a result of the abstraction of underlying parameter values, the user need not have knowledge of these underlying parameter values to specify particular processing for generating an image that is optimal for the user's particular diagnostic purposes.

Previous systems typically display only images reflecting raw diagnostic data 24 and images reflecting the result of combined denoising and enhancement with respect to the raw diagnostic data 24. Previous systems typically do not display a denoised image 32 from the result only of denoising with respect to the raw diagnostic data 24. In certain embodiments, in contrast to previous techniques, the present invention displays simultaneously: (1) a denoised image 32 from the result only of denoising with respect to the raw diagnostic data 24; and (2) an enhanced image 38 from the result of enhancement with respect to the denoised diagnostic data 30. Applying a denoising algorithm 26 to the raw diagnostic data 24 to generate denoised diagnostic data 30 may yield a linear relationship between the raw diagnostic data 24 and the denoised diagnostic data 30, and an accurate and smooth denoised image 32, to facilitate quantitative diagnostic analysis. In certain embodiments, the denoised diagnostic data 30 may be preserved for such analysis. Applying an enhancement algorithm 34 to the denoised diagnostic data 30 to generate enhanced denoised diagnostic data 36 may yield an enhanced image 38 that provides improved visualization (e.g., improved contrast and spatial resolution) and facilitates quantitative diagnostic analysis. In certain embodiments, displaying simultaneously the denoised image 32 with the corresponding enhanced images 38 provides valuable diagnostic benefits.

In certain embodiments, the present invention provides graphical tools to allow the user to adjust, interactively and intuitively, the denoising value to adjust the underlying parameter values of the denoising algorithm 26, the enhancement value to adjust the underlying parameter values of the enhancement algorithm 34, or both. In certain embodiments, the present invention provides graphical tools to allow the user to adjust simultaneously the denoising value and the enhancement value. In certain embodiments, in response to the user adjusting such a user-selected value, the present invention generates and displays in substantially real time a modified image reflecting the adjustment to the associated underlying parameter values. For example, in response to the user adjusting the denoising value, the present invention may generate and display in substantially real time both a new denoising image 32 from the new denoised diagnostic data 30 and a new enhancement image 38 from the corresponding new enhanced denoised diagnostic data 36. In certain embodiments, the ability for the user to intuitively and interactively adjust such values to control the underlying denoising and enhancement algorithms 26 and 34 and associated parameters, and view in substantially real time the results of such adjustments on the denoised and enhanced images 32 and 38, provides valuable diagnostic benefits, especially where the user lacks specialized knowledge of the underlying algorithms and associated parameters.

In certain embodiments, the one or more processing algorithms of the present invention comprise a three-dimensional wavelet-based image processing tool (e.g., a wavelet filter), comprising both the denoising and enhancement functionality. The wavelet filter may be based on multi-scale thresholding and cross-scale regularization. In certain embodiments, the user may be able to adjust one or more denoising parameters and/or one or more enhancement parameters of the wavelet filter using the graphical tools of the present invention.

FIGS. 2A-2D illustrate example interactive diagnostic displays 200, which may be accessed and interacted with by a user of system 10. The displays illustrated in FIGS. 2A-2D are for exemplary purposes only. Displays 200 may comprise GUI 40 displayed on display module 14.

FIG. 2A illustrates an example display 200a, which includes a window 202. Display 200a includes two diagnostic images, a denoised diagnostic image 32 and an enhanced diagnostic image 38. In particular, images 32 and 38 show a transaxial view of a selected portion of a human brain. The portion of denoised image 32 that is displayed corresponds to the portion of enhanced image 38 that is displayed.

Some previous tools for displaying diagnostic data may display an image generated directly from the raw diagnostic data 24 and an image generated after application of denoising and enhancement algorithms to the raw diagnostic data 26. Thus, using such existing tools, a user may be forced to view an unclear or otherwise unsuitable image (i.e., the image generated directly from the raw diagnostic data 24) and the final image (i.e., the image generate after all processing algorithms have been applied to the raw diagnostic data 24). In other words, the user is unable to view any intermediate image (e.g., denoised image 32). Some existing tools do not include any simultaneous display functionality. These and other possible drawbacks of existing tools may limit or impair a user's ability to optimize images generated from diagnostic data 24, for diagnostic purposes for example.

The simultaneous display of denoised image 32 and enhanced image 38 may provide certain advantages. In certain embodiments, the ability to view both denoised image 32 and enhanced image 38 simultaneously according to the present values of the one or more parameters of the processing algorithm, as specified by the user-selected values, may improve a user's ability to optimize the parameters of each of the images.

Display 200a includes various selection icons, displayed in association with denoised image 32 and enhanced image 38, which may allow the user to interactively adjust the user-selected value to adjust the underlying values of the one or more parameters of the processing algorithm for generation of a new image. For example, display 200a includes a denoising selection icon 204, in association with the displayed denoised image 32, allowing a user to interactively adjust the user-selected denoising value to adjust the underlying values of the one or more parameters of denoising algorithm 26 for generation of a new denoised image 32. As another example, display 200a includes an enhancement selection icon 206, in association with the displayed enhanced image 38, allowing a user to interactively adjust the user-selected enhancement value to adjust the underlying values of the one or more parameters of enhancement algorithm 34 for generation of a new enhanced image 38. The current user-selected values are shown in display 200a. For example, the current user-selected denoising value 208 is five, and the current user-selected enhancement value 210 is also five.

The one or more selection icons (e.g., denoising selection icon 204 and enhancement selection icon 206) may have any suitable format, according to particular needs. For example, denoising selection icon 204 may be a first slider 212 allowing the user to slide a first marker 214 along first slider 212 to interactively adjust user-selected denoising value 208. Additionally or alternatively; enhancement selection icon 206 may be a second slider 216 allowing the user to slide a second marker 218 along second slider 216 to interactively adjust user-selected enhancement value 210.

In certain embodiments, display module 14 is operable to display a grid 220 that includes a plurality of columns 222 each corresponding to a particular denoising value and a plurality of rows 224 each corresponding to a particular enhancement value such that each intersection of grid 220 corresponds to a particular combination of denoising and enhancement values. In such embodiments, user selection of a particular intersection of the grid may specify simultaneously the user-selected denoising value 208 and the user-selected enhancement value 210. In certain embodiments, current user-selected denoising value 208 and enhancement value 210 is shown on the grid at intersection 226, which may be shaded distinctively or otherwise highlighted to indicate the current user selections.

In certain embodiments, each of user-selected denoising value 208 and user-selected enhancement value 210 is a number between zero and ten inclusive. Although particular techniques are described for selection of values of the one or more parameters of the processing algorithms (e.g., denoising algorithm 26 and enhancement algorithm 34), the present invention contemplates any suitable technique according to particular needs.

In certain embodiments, display 200a includes an update button 228 that may be used in connection with changes in one or more of the user-selected values. If a user changes one or more of the user-selected values, the lettering on update button 228 may change from grey to black, indicating that the user has made a change and that the user can press update button 228 to update one or more of images 32 and 38. Alternatively, images 32 and 38 may be updated automatically as the user changes one or more of the user-selected values.

In certain embodiments, in response to user selection of a portion of denoised image 32 for display, display module 14 is operable to display simultaneously the selected portion of denoised image 32 and a corresponding portion of enhanced image 38. Similarly, in certain embodiments, in response to user selection of a portion of enhanced image 38 for display, display module 14 is operable to display simultaneously the selected portion of enhanced image 38 and a corresponding portion of denoised image 32.

Display 200a may include various other features. For example, display 200a includes a file pathname identifier 230 that indicates the storage location of the diagnostic data 24 from which images 32 and 38 are generated. As another example, display 200a includes a denoising algorithm-selection icon 232. In this example, the user is given two options for denoising algorithm 26, Hanning denoising and Columbia denoising. As another example, display 200a includes an enhancement algorithm-selection icon 234. In this example, the user is given one option for enhancement algorithm 34, Columbia enhancement. As another example, display 200a includes a slice-selection icon 236, which may be used to select a portion of diagnostic data 24 to be displayed.

Display 200a also includes a plurality of menu options 238, including File, Options, Average/Sum, and View. In this example, an Average/Sum dropdown menu box 240 is displayed, revealing the menu options available for Average/Sum. The menu options in dropdown menu box 240 are No Average, Window Averaging, and Sum Slices. These menu options relate to selection of the appropriate diagnostic data 24 for display. For example, if No Average is selected, then diagnostic data 24 for a single slice is used for generating images. If Window Averaging is selected, then diagnostic data 24 for a selected number of slices may be averaged to determine the appropriate diagnostic data 24 for generating images. If Sum Slices is selected, then diagnostic data 24 for a selected number of slices may be summed to determine the appropriate diagnostic data 24 for generating images. A number-of-slices selection icon 342 may be used in connection with the Window Averaging and Sum Slices to select the number of slices for each of those options. In certain embodiments, as illustrated below with reference to FIGS. 2B-2D, if No Average is selected, then number-of-slices selection icon 342 may be turned a light grey and the user may be blocked from accessing it.

FIG. 2B illustrates an example display 200b. The features of display 200b are substantially similar to those described above with reference to display 200a in FIG. 2A. Display 200b includes two diagnostic images, a denoised diagnostic image 32 and an enhanced diagnostic image 38. In particular, images 32 and 38 show a transaxial view of a selected portion of a human brain. The portion of denoised image 32 that is displayed corresponds to the portion of enhanced image 38 that is displayed.

The Average/Sum selection in display 200b, although the dropdown menu box is not revealed, is No Average. This is apparent due to the light grey color of number-of-slices selection icon 242. In this example, a View dropdown menu box 344 is displayed, revealing the menu options available for View. The menu options in dropdown menu box 244 are Transaxial, Coronol, and Sagittal. These options represent alternative views of the selected region of the patient's body that may be generated using diagnostic data 24. In this example, transaxial is selected, and images 32 and 38 are transaxial views of the selected region (i.e., the brain) of the patient's body.

FIG. 2C illustrates an example display 200c. The features of display 200c are substantially similar to those described above with reference to display 200a in FIG. 2A. Additionally, display 200c is substantially similar to display 200b. However, in FIG. 200c, the coronal view has been selected from drop-down box 244, and the slice selection icon has shifted from twenty-seven to sixty. Images 32 and 38 are coronal views of the selected region (i.e., the brain) of the patient's body.

FIG. 2D illustrates an example display 200d. The features of display 200d are substantially similar to those described above with reference to display 200a in FIG. 2A. Display 200d includes denoised image 32 and enhanced image 38, which show sagittal views of a human brain. Additionally, user-selected denoising value 208 and user-selected enhancement value 210 have been adjusted from five and five, respectively, to two and nine, respectively. In the illustrated example, a user may achieve this adjustment either by independently sliding the first marker 214 of first slider 212 and second marker 218 of second slider 216, or by a selecting intersection 246. Display 200d also includes a warning 248 to the user indicating that one of the parameters has changed.

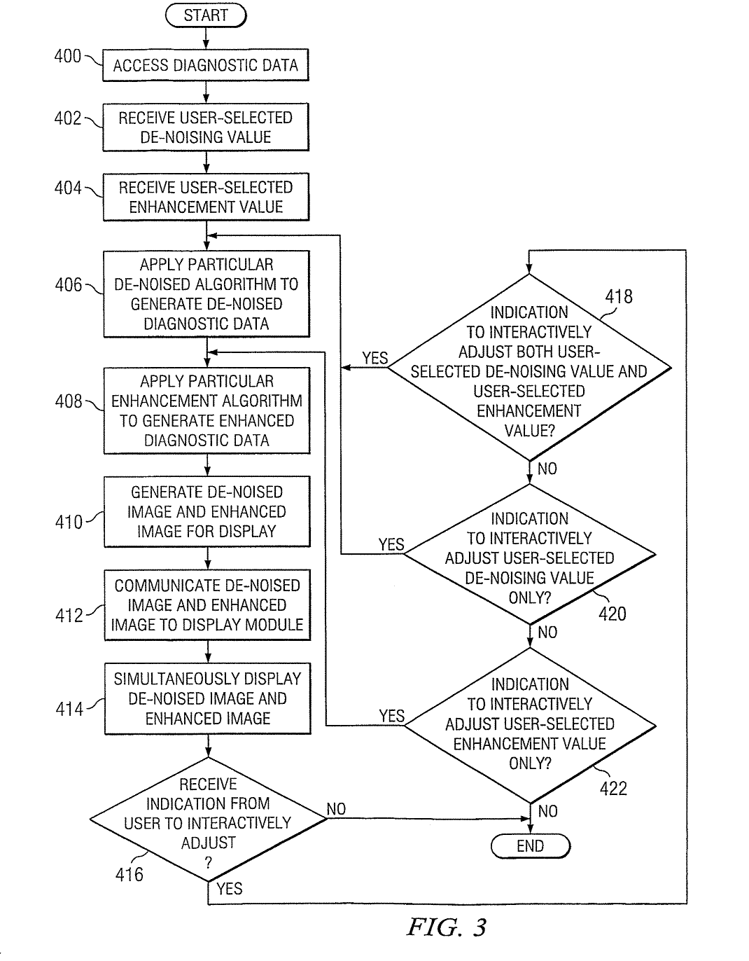

FIG. 3 illustrates an example method for interactive diagnostic display. In certain embodiments, the method may be a computer-implemented method. In the example method described with reference to FIG. 3, the processing algorithms include a denoising algorithm 26 and an enhancement algorithm 34. At 400, processing module 12, at the request of a user of system 10 for example, accesses diagnostic data 24 derived from measurement of one or more characteristics of a selected region of a patient's body. As described above, although diagnostic data 24 derived from measurement of one or more characteristics of a selected region of a patient's body is primarily described, the present invention contemplates diagnostic data 24 being derived from measurement of one or more characteristics of any object. Moreover, although diagnostic data 24 derived using particular types of modalities is described, the present invention contemplates diagnostic data 24 being derived using any suitable modality or other device, according to particular needs.

At 402, processing module 12 receives a user-selected denoising value 208 that specifies underlying values of one or more parameters of a denoising algorithm 26 to specify a particular denoising algorithm 26 that is to be applied to diagnostic data 24 to generate denoised diagnostic data 30. At 404 processing module 12 receives a user-selected enhancement value 210 that specifies underlying values of one or more parameters of an enhancement algorithm 34 to specify a particular enhancement algorithm 34 that is to be applied to denoised diagnostic data 30 to generate enhanced denoised diagnostic data 36. The user-selected values 208 and 210 received at 402 and 404, respectively, may be received in any suitable manner, according to particular needs. As just one example, user-selected values 208 and 210 may be provided by a user of system 10 using one or more input devices 16, such as a keyboard 16a or mouse 16b. In certain embodiments, 402 and 404 may be performed substantially simultaneously. As just one example, in embodiments in which the display includes a selection grid 220, the user may be able to select an intersection of a column and a row that identifies both an user-selected denoised value 208 and a user-selected enhancement value 210.

At 406, processing module 12 may apply the particular denoising algorithm 26 to diagnostic data 24 to generate denoised diagnostic data 30. At 408, processing module 12 may apply the particular enhancement algorithm 34 to denoised diagnostic data 30 to generate enhanced denoised diagnostic data 36. At 410, processing module 12 may generate for simultaneous display: (a) denoised image 32 from denoised diagnostic data 30 according to user-selected denoising value 208; and (b) enhanced image 38 from enhanced denoised diagnostic data 36 according to user-selected enhancement value 210. Although generation of denoised image 32 and enhanced image 38 is described as 410, the present invention contemplates the generation of denoised image 32 and the generation of enhanced image 38 being substantially simultaneous or at different times, according to particular needs.

At 412, processing module 12 communicates denoised image 32 and enhanced image 38 for display. For example, processing module 12 may communicate denoised image 32 and enhanced image 38 to display module 14 for display. Although communication of denoised image 32 and enhanced image 38 for display is described as 412, the present invention contemplates the communication of denoised image 32 and the communication of enhanced image 38 being substantially simultaneous or at different times, according to particular needs. At 414, display module displays simultaneously denoised image 32 reflecting user-selected denoising value 208 and enhanced image 38 reflecting user-selected enhancement value 210.

At 416, processing module 12 determines whether it has received an indication from a user to interactively adjust: (a) user-selected denoising value 208 to adjust the underlying values of the one or more parameters of denoising algorithm 26 for generation of a new denoised image 32; (b) user-selected enhancement value 210 to adjust the underlying values of the one or more parameters of enhancement algorithm 34 for generation of a new enhanced image 38; or (c) both. If processing module 12 determines at 416 that it has not received one of these types of indications from the user, then the method may end. Alternatively, processing module may wait for such an indication from the user until the software application supporting the interactive diagnostic display system 10 is terminated.

If at 416 processing module 12 determines that it has received such an update, then processing module 12 may determine at 418 through 422 the type of indication it received from the user. At 418, processing module 12 determines whether the user is requesting to interactively adjust both user-selected denoising value 208 and user-selected enhancement value 210. If processing module 12 determines at 416 that the user is requesting to interactively adjust both user-selected denoising value 208 and user-selected enhancement value 210, then the method may repeat 406-414 to generate: (1) a new denoised image 32 from new denoised diagnostic data 30 generated according to the adjusted user-selected denoising value 208; and (2) a new enhanced image 38 from new enhanced denoised diagnostic data 36 generated according to the adjusted user-selected enhancement value 210. This type of indication from the user may result, for example, if the user selects a new intersection on grid 220. If processing module 12 determines at 416 that the user is not requesting to interactively adjust both user-selected denoising value 208 and user-selected enhancement value 210, then the method proceeds to 420.

At 420, processing module 12 determines whether the user is requesting to interactively adjust only user-selected denoising value 208. If processing module 12 determines at 420 that the user is requesting to interactively adjust only user-selected denoising value 208, then the method may repeat 406-414 to generate: (1) a new denoised image 32 from new denoised diagnostic data 30 generated according to the adjusted user-selected denoising value 208; and (2) a new enhanced image 38 from new enhanced denoised diagnostic data 36 generated according to the adjusted user-selected enhancement value 210. In certain embodiments, a new enhanced image 38 may be generated because enhanced denoised diagnostic data 36 (from which enhanced image 38 is generated) is generated by applying the particular enhancement algorithm 34 to denoised diagnostic data 30, which may have changed due to the user's request. This type of indication from the user may result, for example, if the user repositions only denoising selection icon 204. If processing module 12 determines at 420 that the user is not requesting to interactively adjust only user-selected denoising value 208, then the method proceeds to 422.

At 422, processing module 12 determines whether the user is requesting to interactively adjust only user-selected enhancement value 210. If processing module 12 determines at 422 that the user is requesting to interactively adjust only user-selected enhancement value 210, then the method may repeat 408-414 to generate a new enhanced image 38 from new enhanced denoised diagnostic data 36 generated according to the adjusted user-selected enhancement value 210. This type of indication from the user may result, for example, if the user repositions only enhancement selection icon 206. In certain embodiments, as may be the case with the example method illustrated in FIG. 3, a denoised image 32 may be refreshed with the same image when a new enhanced image 38 is displayed through this repetition of 408 through 414. In certain other embodiments, the portion of 410 through 414 relating to updating denoised image 32 may be ignored. If processing module 12 determines at 422 that the user is not requesting to interactively adjust only user-selected enhancement value 210, then, in this example, an error has likely occurred. Processing module 12 could handle this situation in any suitable manner. For example, processing module 12 could report the error, keep the current display, or both.

Although a particular method has been described with reference to FIG. 3, the present invention contemplates any suitable methods for performing the operations of system 10 in accordance with the present invention. Thus, certain of the steps described with reference to FIG. 3 may take place simultaneously and/or in different orders than as shown. Moreover, system may use methods with additional steps, fewer steps, and/or different steps, so long as the methods remain appropriate.

### Example Processing Algorithm

The following description provides additional details regarding the one or more processing algorithms used to generate the one or more images provided by the interactive diagnostic display system of the present invention. It should be understood that this description is merely for example purposes and should not be used to limit the present invention. Moreover, the following algorithm may provide one or both of the denoising and enhancement algorithms of the present invention.

In certain embodiments, the one or more processing algorithms comprise a multi-scale adaptive thresholding scheme, which may provide a regularization process to filtered back-projection (FBP) for reconstructing diagnostic data 24. Adaptive selection of thresholding operators for each multi-scale sub-band may enable a unified process for noise removal and feature enhancement. A cross-scale regularization process may provide an effective signal recovering operator, Together with non-linear thresholding and enhancement operators, the multi-scale adaptive thresholding scheme may provide desirable post-processing of FBP reconstructed data.

Typical tomographic reconstruction techniques may be based on an FBP algorithm. Mathematically, a 2-D inverse radon transform may be implemented by first applying a ramp filter to the input sinogram and then “back-projecting” the filtered data into a planar image. A ramp filter is a typical high-pass filter that amplifies high frequency components of the input data. When noise exists, it generally occupies higher frequency sections of the spectrum. Using a ramp filter in the FBP process may result in noise amplification. Because of the noise and statistical fluctuations associated with nuclear decay, compounded by acquisition constraints, such as suboptimal sampling and the effects of attenuation, scatter, and collimator and detector constraints, high levels of noise may exist in clinical PET data or other types of diagnostic data 24. A regularization filtering process may be used in tomographic reconstruction to alleviate the noise amplification problem.

Previous and existing techniques for reducing noise typically combine a low pass filter together with the ramp filter to eliminate part of the high frequency spectrum. Using a low-pass filter may suppress the high frequency noise, but with the possible sacrifice of image contrast and resolution, as well as detailed spatial information. In certain embodiments, an important procedure in tomographic reconstruction is to find a best trade-off between signal-to-noise ratio and contrast/resolution of the reconstructed image. In clinical environments, for example, post-processing involving de-noising and enhancement is often applied to improve image quality of the reconstructed data.

Wavelets may be applied to tomographic imaging in many aspects. For example, local reconstruction to improve spatial resolution within a region of interest (e.g., a selected region of a patient's body) may be an application of wavelets to tomographic imaging. Due to multi-resolution analysis, wavelets may be used to accelerate implementations of the traditional FBP algorithm.

As a successful de-noising tool, wavelet methods of analysis may be used as post-filtering or regularization/constraints to tomographic reconstruction. In certain embodiments, an effective de-noising technique to tomographic images (e.g., PET and SPECT) may comprise the following: (1) post-processing of tomographic images (e.g., PET/SPECT) reconstructed using clinical protocol; and (2) regularization of FBP to improve the reconstruction image quality. The following provides an example methodology for the regularization of PET (or other diagnostic data 24) reconstruction using multi-scale adaptive thresholding. Throughout the description, the term “signal” may refer to diagnostic data 24.

### A. Wavelet Modulus Analysis

In general, the wavelet transform of a signal f(x) at scale s with translation u is defined by the following:

$$Wf ( u , s ) = f * {ψ}_{u , s} = \int f ( x ) \frac{1}{\sqrt{s}} ψ * ( \frac{x - u}{s} ) d x .$$

A discrete wavelet transform may be obtained from a continuous representation by discretizing dilation and translation parameters such that the resulting set of wavelets constitutes a frame. The dilation parameter may be discretized by an exponential sampling with a fixed dilation step and the translation parameter by integer multiples of a dilation dependent step. However, the resulting transform is variant under translation, a property which may render it less attractive for the analysis of non-stationary signals.

Sampling the translation parameter with the same sampling period as the input function to the transform may result in a translation-invariant, but slightly redundant representation. The dyadic wavelet transform of a function s(x)ε=L²(R) may be defined as a sequence of functions {Xₘs(x)}_{mεZ}, where:

$${W}_{m} s ( x ) = s * {ψ}_{m} ( x ) = {\int }_{- ∞}^{+ ∞} s ( t ) {ψ}_{m} ( x - t ) d t$$

and ψₘ(x)=2^{-m}ψ*2^{-m}x) is a wavelet Ψ(x) expanded by a dilation parameter (or scale) 2^{m}.

Discrete dyadic wavelet transform may be implemented within a hierarchical filtering scheme. For an N-dimensional discrete dyadic wavelet transform decomposition, the wavelet coefficients (i.e., sub-band expansion) may comprise N components for each level (scale), which represent information along each coordinate direction at a certain scale, and a DC component, which represents the “residue” information or average energy distribution.

Using the first derivative of a cubic spine function as the wavelet bases, the three components of a 3-D dyadic wavelet coefficient Wₘ^{k}s(n₁, n₂, n₃)=<s, ψ_{m,n}_{₁}_{,n}_{₂}_{,n}_{₃}>, k=1, 2, 3 may be proportional to the coordinate components of the gradient vector of an input image s smoothed by a dilated version of a cubic spine function θ. From these coordinate components, the direction of the gradient vector may be computed, which may indicate the direction in which the first derivative of the smoothed s has the largest amplitude (or the direction in which s changes the most rapidly in a local neighborhood). The amplitude of this maximized first derivative is equal to the modulus of the gradient vector, and therefore proportional to the wavelet modulus:

Mₘf=\sqrt{|Wₘ¹f|²+|Wₘ²f|²+|Wₘ³f|²}.

Applying a threshold value to the wavelet modulus may be equivalent to selecting first a direction in which the partial derivative is maximum at each scale, and thresholding the amplitude of the partial derivatives in this direction. The coefficients of the dyadic wavelet expansion may then be computed from the thresholded modulus and the direction of the gradient vector (which was preserved during the thresholding process). Such a paradigm may apply an adaptive choice of the spatial orientation in order to correlate the signal, which may provide a more flexible and accurate orientation analysis to correlated signals when compared to traditional thresholding schemes that analyze on three orthogonal Cartesian directions separately. The flexibility and accuracy of these orientation analyses may be particularly beneficial in higher dimensional space. Moreover, in certain embodiments, applying the denoising in a three-dimensional space may take advantage of better separation of noise and signal in higher dimensions and the availability of volumetric features in true three-dimensional data sets.

### B. Multi-scale Adaptive Thresholding

In general, wavelet coefficients with a larger magnitude are related to significant features such as edges in an image. Therefore, denoising may be achieved by expansion of a signal onto a set of wavelet basis functions, thresholding of the wavelet coefficients, and reconstructing back to the original image (spatial) domain.

Typical threshold operators that have been used previously include hard thresholding:

$${ρ}_{T} ( x ) = \{ \begin{matrix}x , & if \vert x \vert > T \\ 0 , & if \vert x \vert \leq T\end{matrix}$$

and soft thresholding (wavelet shrinkage):

$${ρ}_{T} ( x ) = \{ \begin{matrix}x - T & if x \geq T \\ x + T & if x \geq - T \\ 0 , & if \vert x \vert < T\end{matrix}$$

Redundancy in a particular expansion may exploited for image denoising by first modifying transform coefficients at selected levels of spatial frequency and then reconstructing. The thresholding function can be implemented independent of a particular set of filters and incorporated into a filter bank framework to provide multi-scale denoising. For N-dimensional data, for example, each level of a wavelet expansion may have N components, and the thresholding operator may be applied to each of component individually.

Similar to the one-dimensional case, a three-dimensional dyadic wavelet basis may be computed from a set of three wavelets (ψ¹, ψ², ψ³) that are the partial derivatives of a smoothing function θ:

$${ψ}^{1} ( x , y , z ) = \frac{\partial θ ( x , y , z )}{\partial x} , \\ {ψ}^{2} ( x , y , z ) = \frac{\partial θ ( x , y , z )}{\partial y} , \\ {ψ}^{3} ( x , y , z ) = \frac{\partial θ ( x , y , z )}{\partial z} .$$

The dilation and translation of ψ^{k} may be denoted as:

$${ψ}_{j , l , m , n}^{k} ( x , y , z ) = \frac{1}{{2}^{3 jl 2}} {ψ}^{k} ( \frac{x - 1}{{2}^{j}} , \frac{y - m}{{2}^{j}} , \frac{z - n}{{2}^{j}} ) .$$

Thus, the dyadic wavelet transform of a volume image F at a scale 2^{j} may have three components:

Tⱼ^{k}F(l,m,n)=<F,ψ_{j,l,m,n}^{k}>, k=1, 2, 3.

Because (ψ¹, ψ², ψ³) are partial derivatives of θ, the three components are proportional to the three coordinate components of the gradient vector of F smoothed by a dilated version of θ. From these components, the angle of the gradient vector may be computed, which may indicate the direction in which the signal (a smoothed version of F) changes the most rapidly. The magnitude of this vector may be proportional to the wavelet modulus:

MⱼF=\sqrt{|Tⱼ¹F|²+|}Tⱼ²F|²|Tⱼ³F|².

In certain embodiments, substantially different signal-to-noise relations exist within distinct sub-bands of wavelet coefficients. Given such considerations, suitable thresholding and enhancement operators may be adaptively selected based on the signal-noise characteristics for each expansion sub-band. As a particular non-limiting example, for diagnostic data 24 that comprises clinical PET brain, the following thresholding and enhancement operators may be applied:

1. For the first expansion level, the traditional thresholding operator may not be able to recover signal related features. Therefore, it may be appropriate to apply a more sophisticated “thresholding” scheme was applied, such as cross-scale regularization.

2. The second expansion level may include detailed structural information. In certain embodiments, a piece-wise linear enhancement operator may be applied, which may increase the strength of signal features.

3. Higher levels of wavelet sub-bands may be processed using an affine threshold operator for de-noising.

### C. Cross-Scale Regularization

In certain embodiments, to recover signal related features in noise dominated wavelet sub-bands, cross-scale regularization may be used. An edge indication map may be constructed using the next higher level of wavelet sub-bands. A selected wavelet sub-band may then be multiplied with the edge map to preserve signal related wavelet coefficients. The success of this cross-scale regularization process may result from the general rule that random noise tends to have a different singularity (e.g., negative Lipschitz regularity) from coherent signal features, and therefore decreases steeply when wavelet scales increase. Thus, noise components usually have a very low coherence across wavelet expansion levels.

For images with high levels of noise, cross-scale regularization may offer improved capability for recovering detailed signal features when compared to conventional thresholding schemes. This cross-scale regularization process may help recover subtle signal features from the finer levels of a wavelet expansion.

### D. Multi-Scale Regularized FBO (MFBP)

In certain embodiments, by embedding a multi-scale de-noising module as an extra regularization process (i.e., as an alternative to the traditional low-pass filter), an improved tomographic reconstruction may result. One example technique for implementing such a concept is to include more high frequency features during the FBP reconstruction (e.g., by using a low-pass filter with a limited high frequency cut-off parameter). For example, an additional amount of noise accompanied with detailed information of the signal (e.g., the diagnostic data 24) may be recovered by more sophisticated de-noising.

Although the present invention has been described in several embodiments, diverse changes, substitutions, variations, alterations, and modifications may be suggested to one skilled in the art, and it is intended that the invention may encompass all such changes, substitutions, variations, alterations, and modifications falling within the spirit and scope of the appended claims.

What is claimed is:

1. An interactive diagnostic display system, comprising:
one or more memory modules including diagnostic data derived from measurement of one or more characteristics of a patient's body;
one or more digital processing modules operable to:
receive a denoising value that corresponds to values for one or more parameters of a denoising algorithm;
receive an enhancement value that corresponds to values for one or more parameters of an enhancement algorithm;
based on the values for the one or more parameters of the denoising algorithm that correspond to the denoising value, apply the denoising algorithm to the diagnostic data to generate denoised diagnostic data;
based on the values for the one or more parameters of the enhancement algorithm that correspond to the enhancement value, apply the enhancement algorithm to the denoised diagnostic data to generate the enhanced denoised diagnostic data;
generate a denoised image from the denoised diagnostic data and an enhanced image from the enhanced denoised diagnostic data; and
a display operable to display simultaneously the denoised image and the enhanced image.

2. The system of claim 1, wherein the display module is further operable to:
display a denoising selection icon, in association with the displayed denoised image, allowing interactive adjustment if the denoising value to adjust the values for the one or more parameters of the denoising algorithm for generation of a new denoised image; and
display an enhancement selection icon, in association with the displayed enhanced image, allowing interactive adjustment of the enhancement value to adjust the values for the one or more parameters of the enhancement algorithm for generation of a new enhanced image.

3. The system of claim 2, wherein:
the denoising selection icon comprises a first slider allowing sliding of a first marker along the first slider to interactively adjust the denoising value; and
the enhancement selection icon comprises a second slider allowing sliding of a second marker along the second slider to interactively adjust the enhancement value.

4. The system of claim 1, wherein:
the display module is operable to display a grid comprising a plurality of columns each corresponding to a particular denoising value and a plurality of rows each corresponding to a particular enhancement value such that each intersection of the grid corresponds to a particular combination of denoising and enhancement values; and
selection of a particular intersection of the grid specifies simultaneously the denoising value and the enhancement value.

5. The system of claim 1, wherein:
in response to selection of a portion of the denoised image for display, the display module is operable to display simultaneously the selected portion of the denoised image and a corresponding portion of the enhanced image; and
in response to selection of a portion of the enhanced image for display, the display module is operable to display simultaneously the selected portion of the enhanced image and a corresponding portion of the denoised image.

6. The system of claim 1, wherein the denoising algorithm comprises a cross-scale regularization algorithm.

7. The system of claim 1, wherein the diagnostic data comprises one of:
positron emission tomography (PET) data;
single photon emission computed tomography (SPECT) data;
computerized tomography (CT) scan data;
computed axial tomography (CAT) scan data;
magnetic resonance imaging (MRI) data;
electro-encephalogram (EEG) data;
ultrasound data; and
single photon planar data.

8. Software for interactive diagnostic display, the software being embodied in one or more computer-readable media and when executed operable to:
receive a denoising value that corresponds to values for one or more parameters of a denoising algorithm;
receive an enhancement value that corresponds to values for one or more parameters of an enhancement algorithm;
based on the values for the one or more parameters of the denoising algorithm that correspond to the denoising value, apply the denoising algorithm to diagnostic data to generate denoised diagnostic data, the diagnostic data derived from measurement of one or more characteristics of a patient's body;
based on the values for the one or more parameters of the enhancement algorithm that correspond to the enhancement value, apply the enhancement algorithm to the denoised diagnostic data to generate the enhanced denoised diagnostic data; and
generate for simultaneous display a denoised image from the denoised diagnostic data and an enhanced image from the enhanced denoised diagnostic data.

9. The software of claim 8, further operable to generate for display:
a denoising selection icon, in association with the displayed denoised image, allowing interactive adjustment of the denoising value to adjust the values for the one or more parameters of the denoising algorithm for generation of a new denoised image; and
an enhancement selection icon, in association with the displayed enhanced image, allowing interactive adjustment of the enhancement value to adjust the values for the one or more parameters of the enhancement algorithm for generation of a new enhanced image.

10. The software of claim 9, wherein:
the denoising selection icon comprises a first slider allowing sliding of a first marker along the first slider to interactively adjust the denoising value; and
the enhancement selection icon comprises a second slider allowing sliding of a second marker along the second slider to interactively adjust the enhancement value.

11. The software of claim 8, further operable to generate for display a grid comprising a plurality of columns each corresponding to a particular denoising value and a plurality of rows each corresponding to a particular enhancement value, each intersection of the grid corresponds to a particular combination of denoising and enhancement values, selection of a particular intersection of the grid specifying simultaneously the denoising value and the enhancement value.

12. The software of claim 8, further operable to:
in response to selection of a portion of the denoised image for display, generate for simultaneous display the selected portion of the denoised image and a corresponding portion of the enhanced image; and
in response to selection of a portion of the enhanced image for display, generate for simultaneous display the selected portion of the enhanced image and a corresponding portion of the denoised image.

13. The software of claim 8, wherein the denoising algorithm comprises a cross-scale regularization algorithm.

14. The software of claim 8, wherein the diagnostic data comprises one of:
positron emission tomography (PET) data;
single photon emission computed tomography (SPECT) data;
computerized tomography (CT) scan data;
computed axial tomography (CAT) scan data;
magnetic resonance imaging (MRI) data;
electro-encephalogram (EEG) data;
ultrasound data; and
single photon planar data.

15. A method for interactive diagnostic display, comprising:
receiving a denoising value that corresponds to values for one or more parameters of a denoising algorithm;
receiving an enhancement value that corresponds to values for one or more parameters of an enhancement algorithm;
based on the values for the one or more parameters of the denoising algorithm that correspond to the denoising value, applying the denoising algorithm to diagnostic data to generate denoised diagnostic data, the diagnostic data derived from measurement of one or more characteristics of a patient's body;
based on the values for the one or more parameters of the enhancement algorithm that correspond to the enhancement value, applying the enhancement algorithm to the denoised diagnostic data to generate the enhanced denoised diagnostic data; and
generating for simultaneous display a denoised image from the denoised diagnostic data and an enhanced image from the enhanced denoised diagnostic data.

16. The method of claim 15, further comprising generating for display:
a denoising selection icon, in association with the displayed denoised image, allowing interactive adjustment of the denoising value to adjust the values for the one or more parameters of the denoising algorithm for generation of a new denoised image; and
an enhancement selection icon, in association with the displayed enhanced image, allowing interactive adjustment of the enhancement value to adjust the values for the one or more parameters of the enhancement algorithm for generation of a new enhanced image.

17. The method of claim 16, wherein:
the denoising selection icon comprises a first slider allowing sliding of a first marker along the first slider to interactively adjust the denoising value; and
the enhancement selection icon comprises a second slider allowing sliding of a second marker along the second slider to interactively adjust the enhancement value.

18. The method of claim 15, further comprising generating for display a grid comprising a plurality of columns each corresponding to a particular denoising value and a plurality of rows each corresponding to a particular enhancement value, each intersection of the grid corresponds to a particular combination of denoising and enhancement values, selection of a particular intersection of the grid specifying simultaneously the denoising value and the enhancement value.

19. The method of claim 15, further comprising:
in response to selection of a portion of the denoised image for display, generating for simultaneous display the selected portion of the denoised image and a corresponding portion of the enhanced image; and
in response to selection of a portion of the enhanced image for display, generating for simultaneous display the selected portion of the enhanced image and a corresponding portion of the denoised image.

20. An interactive diagnostic display system, comprising:
a database including:
diagnostic data based on measurements of one or more characteristics of a patient's body;
denoising algorithms, each of the denoising algorithms corresponding to a value of a denoising parameter; and
enhancement algorithms, each of the enhancement algorithms corresponding to a value of an enhancement parameter;
a digital data processing device operatively coupled to the database and configured to:
receive a denoising value and an enhancement value from a client input device,
based on the denoising value, apply the corresponding one of the denoising algorithms to the diagnostic data to generate denoised diagnostic data,
based on the enhancement value, apply the corresponding one of the enhancement algorithms to the denoised diagnostic data to generate enhanced denoised diagnostic data, and
generate denoised and enhanced denoised images based on the respective denoised diagnostic data and the enhanced denoised diagnostic data; and
a display operatively coupled to the digital data processing device and configured to simultaneously display the denoised diagnostic data and the enhanced denoised diagnostic data.
